(19) United States
(12) Patent Application Publication
(10) Pub. No.: US 2026/0197306 A1
(43) Pub. Date: Jul. 9, 2026

(54) DYNAMIC KEY ENCRYPTION

(71) Applicant: Bank of America Corporation, Charlotte, NC (US)

(72) Inventors: Saurabh Kumar, Gurugram Haryana (IN); Yedluri Praveen Chakravarthy, Hyderabad Telangana (IN); Vital Surya Narayana Goli, Hyderabad Telangana (IN); Vishal Gupta, Kondapur Hyderabad (IN); Ashisa Kumar Nayak, Hyderabad Telangana (IN); Swati Pandey, Hyderabad Telangana (IN); Raja Boyina, Pennington, NJ (US)

(21) Appl. No.: 19/014,767

(22) Filed: Jan. 9, 2025

(51) Int. Cl. H04L 9/40; H04L 9/08; H04L 9/32

(52) U.S. Cl. CPC H04L 63/0435; H04L 9/0866; H04L 9/3242

(57) ABSTRACT

Apparatus and methods for dynamic key encryption are provided. The apparatus and methods may include an encryption server, a hardware security module, and a user device. The hardware security module may generate a static symmetric key. The server may generate a random initialization vector. The random initialization vector may be hashed. The hash may be combined with the static symmetric key to generate a dynamic key. The dynamic key may then be used to encrypt data. The encrypted data may be bundled with the random initialization vector to decrypt the data with the dynamic key.

### FIELD OF TECHNOLOGY

Aspects of the disclosure relate to providing dynamic key encryption with a hardware security module.

### BACKGROUND OF THE DISCLOSURE

Current standard encryption methods typically use symmetric encryption mechanisms to create a static data encryption key (“DEK”) for every application. This key is generally used to perform several crypto operations including encryption, decryption, hash-based message authentication code (“HMAC”) and verifying a HMAC message.

Usage of symmetric keys, as they are static, for large data sets and for long times can potentially introduce a widespread data breach if the key is compromised by a malicious actor. A compromised static key may result in an unauthorized access to all encrypted data. At the same time, creation of multiple static keys for the same application could result in significant overhead around key management. Replacing the static key with another static key may also be cumbersome.

To address this, the invention creates application specific symmetric keys with hardware security module(s) (“HSM”), and these keys may then be used to generate derived or dynamic keys. The generated dynamic keys may then be used to perform crypto operations including encryption, decryption, HMAC, and verifying HMAC.

Currently, there is no apparatus or method available to provide dynamic key encryption services with a hardware security module.

Therefore, it would be desirable for apparatus and methods for providing dynamic key encryption services with a hardware security module.

### SUMMARY OF THE DISCLOSURE

It is an object of this disclosure to provide apparatus and methods for dynamic key encryption services with a hardware security module.

An apparatus for dynamic key encryption is provided. The apparatus may include a central encryption server and a user device.

The central encryption server may include a server communication link, a server processor, a hardware security module, and a server non-transitory memory. The server non-transitory memory may be configured to store at least a server operating system and a dynamic key encryption program executed on the server processor.

The user computing device may include a device communication link, a device processor, and a device non-transitory memory. The device memory may be configured to store at least a device operating system and a user interface program executed on the device processor. The user interface program may be adapted to interact with the dynamic key encryption program on the central encryption server.

The dynamic key encryption program may create an application symmetric key with the hardware security module as an initial step. This application symmetric key may be static. The application symmetric key may be assigned to a specific application (such as, e.g., an email program).

The dynamic key encryption program may receive, over a network, a request for a dynamic key from a user interacting with the user interface on the user device.

The dynamic key encryption program may generate a random initialization vector with the hardware security module. In an embodiment, the server may generate the random initialization vector without the hardware security module.

The dynamic key encryption program may generate a hash of the random initialization vector with a hashing algorithm. Any suitable hashing algorithm may be used.

The dynamic key encryption program may generate an hash-based message authentication code (“HMAC”) hash output of the hash with the application symmetric key to create a dynamic key.

The dynamic key encryption program may transmit the dynamic key to the user interface program.

The user interface program may encrypt data with the dynamic key to create an encrypted output.

The encrypted output may include the encrypted data, a key identifier, and the random initialization vector.

In an embodiment, the network may be the Internet.

In an embodiment, the network may be an internal intranet.

In an embodiment, the application symmetric key may be 256-bit.

In an embodiment, the application symmetric key may be longer than 256-bit.

In an embodiment, the hashing algorithm may include a SHAKE256 encryption algorithm.

In an embodiment, to decrypt the encrypted data, the dynamic key encryption program may receive the encrypted output, determine that the encrypted output was generated with a dynamic key by reviewing the key identifier, parse the random initialization vector from the encrypted output, generate a second hash of the random initialization vector with the hashing algorithm, generate a second HMAC hash output of the hash with the application symmetric key to re-create the dynamic key, and decrypt the encrypted data with the re-created dynamic key.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4 shows an illustrative schematic in accordance with principles of the disclosure.

FIG. 5 shows an illustrative flowchart in accordance with principles of the disclosure.

FIG. 6 shows an illustrative apparatus in accordance with principles of the disclosure.

### DETAILED DESCRIPTION OF THE DISCLOSURE

It is an object of this disclosure to provide apparatus and methods for providing dynamic encryption keys.

An apparatus for dynamic key encryption is provided. The apparatus may include a central encryption server and a user device. In other embodiments, the encryption server may be decentralized. There may be tradeoffs between centralized and decentralized servers such as cost, computing power, security, power usage, location, and others.

In an embodiment, the server may be centralized. In an embodiment, the server may be distributed, to utilize a larger pool of computing resources and provide redundancy. Centralized servers may be easier to secure but also provide a single failure point. Distributed servers may be more robust but may provide multiple avenues for malicious actors to target.

The central encryption server may include a server communication link, a server processor, a hardware security module, and a server non-transitory memory. The server non-transitory memory may be configured to store at least a server operating system and a dynamic key encryption program executed on the server processor.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The non-transitory memory may be configured to store executable data configured to run on the processor.

The microprocessors may control the operation of the computer system and its components, which may include RAM, ROM, an input/output module, and other memory.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, bluetooth, LAN, and cellular links. Multiple communication links may be present. In an embodiment, the network used to communicate may be the Internet. In another embodiment, the network may be an internal intranet or other internal network.

The user computing device may include a device communication link, a device processor, and a device non-transitory memory. The device memory may be configured to store at least a device operating system and a user interface program executed on the device processor. The user interface program may be adapted to interact with the dynamic key encryption program on the central encryption server.

A hardware security module may be a physical computing device that may include one or more processors, non-transitory memory, and other computing components. Some hardware security modules may have a plug-in computing card form factor (such as PCI or PCIe) that requires a separate computer or server for it to be placed within.

Other hardware security modules may be standalone external devices that may be in communication with a computer or server over a network. The network may be wireless or wired.

In some embodiments, hardware security modules may perform various functions, such as key generation, key storage, and key management.

The dynamic key encryption program may create one or more application symmetric keys with the hardware security module as an initial step. The hardware security module may generate the symmetric key.

This application symmetric key may be static. The application symmetric key may be assigned to a specific application (such as, e.g., an email program).

Standard keys may be referred to as symmetric keys. Symmetric keys are not dynamic.

The dynamic key encryption program may receive, over a network, a request for a dynamic key from a user interacting with the user interface on the user device. For example, the user may desire to transmit an encrypted message (e.g., an email). To encrypt the message, the user may select “dynamic key” from a list on the user interface, or through some other selection method.

In an embodiment, the network may be the Internet. In another embodiment, the network may be an internal intranet. An internal intranet may be more limited than the Internet, but it may also be more secure. In an embodiment, the network may be encrypted. In an embodiment, the program may use both an internal intranet as well as an external network. For example, the encryption server may be part of an internal intranet, but after the data is encrypted with the dynamic key, the encrypted data may be transmitted over an external network. This may reduce the opportunities for a malicious actor to intercept unencrypted data.

After receiving the request for a dynamic key, the dynamic key encryption program may generate a random initialization vector with the hardware security module. An initialization vector may be a starting variable used to provide an initial state for a cryptographic function or program. Randomizing the initialization vector may increase the security of the encryption program. In an embodiment, the randomization may be non-repeating, i.e., once a random initialization vector is generated, it may never be used by the program again, at least until the program is reset.

Longer and more complex initialization vectors may be more secure.

In an embodiment, the server may generate the random initialization vector without the hardware security module or with a different hardware security module. Depending on the algorithm used to generate the random initialization vector, unique hardware or more powerful hardware may be required.

The dynamic key encryption program may generate a hash of the random initialization vector with a hashing algorithm. Any suitable hashing algorithm may be used.

The dynamic key encryption program may generate a hash-based message authentication code (“HMAC”) hash output of the hash with the application symmetric key to create a unique and dynamic encryption key.

HMAC may refer to a standard message authentication paradigm. HMAC may refer to a cryptographic technique that verifies the integrity and authenticity of data being transmitted between two parties by creating a unique hash for each message using a secret key, and then sending that hash along with the message. The recipient can then generate their own hash using the same secret key and the received message. If the two hashes match, the data may be considered authentic and has not been tampered with by a malicious actor.

In this disclosure, a HMAC algorithm may be used to create a unique hash output of the hash of the initialization vector and the application symmetric key, to create a dynamic encryption key.

Combining the application symmetric key (which is static) with the hash of the random initialization vector (which is dynamic and changes with each request) may be used to generate a dynamic key.

The dynamic key encryption program may transmit the dynamic key to the user interface program. In an embodiment, the HMAC hash output may be transmitted in addition to, or instead of the dynamic key. Transmitting the HMAC hash output may allow the dynamic key to be verified.

The user interface program may encrypt data with the dynamic key to create an encrypted output. Any encryption method that uses a key may be used.

The encrypted output may include the encrypted data (or message), metadata, a key identifier, and the random initialization vector.

In an embodiment, the metadata, key identifier, and the random initialization vector may be in cleartext or plaintext.

The key identifier may be a descriptive flag. The key identifier may identify the type of key used, such as a standard key, a dynamic key, or other key.

In an embodiment, the application symmetric key may be 256-bit. 256-bit may be the industry standard for most industries.

In an embodiment, the application symmetric key may be longer than 256-bit. Shorter keys are generally not secure. The longer the key may be, the more secure the encryption may be. Longer keys may be exponentially harder for a malicious actor to crack compared to shorter keys.

In an embodiment, the hashing algorithm may include a SHAKE256 encryption algorithm. The SHAKE256 encryption algorithm may refer to a particular standardized 256-bit encryption algorithm.

In an embodiment, to decrypt the encrypted data, the dynamic key encryption program may perform some of the steps in reverse, or may repeat some of the same steps.

The dynamic key encryption program may receive the encrypted output, determine that the encrypted output was generated with a dynamic key by reviewing the key identifier, parse the random initialization vector from the encrypted output, generate a second hash of the random initialization vector with the hashing algorithm, generate a second HMAC hash output of the hash with the application symmetric key to re-create the dynamic key, and decrypt the encrypted data with the re-created dynamic key. If the data in the encrypted output (such as the random initialization vector) and algorithms match, the re-created dynamic key will be the same as the original dynamic key, allowing for decryption of the data in the encrypted output.

An apparatus for dynamic key encryption is provided. The apparatus may include an encryption server, a hardware security module, and a user device.

The encryption server may include a server communication link, a server processor, and a server non-transitory memory. The memory may be configured to store at least a server operating system, and a dynamic key encryption program executed on the server processor. The encryption server may be centralized or decentralized.

The hardware security module may include a static symmetric key generator and a communications link. The hardware security module may create an application-specific static symmetric key and transmit the application-specific static symmetric key to the encryption server.

The user device may include a device communication link, a device processor, and a device non-transitory memory. The device memory may be configured to store at least a device operating system, and a user interface program executed on the device processor and adapted to interact with the dynamic key encryption program.

The user interface may be a graphical user interface.

The dynamic key encryption program may include one or more modules. Each module may be configured to perform one or more functions.

The dynamic key encryption program on the encryption server may receive the application-specific static symmetric key from the hardware security module.

The dynamic key encryption program on the encryption server may receive, over a network and from a user interacting with the user interface, a request to encrypt data with a dynamic key and the data to be encrypted.

The dynamic key encryption program on the encryption server may generate a random initialization vector.

The dynamic key encryption program on the encryption server may generate a hash of the random initialization vector with a hashing algorithm.

The dynamic key encryption program on the encryption server may generate an HMAC hash output of the hash with the application-specific symmetric key to create a dynamic key.

The dynamic key encryption program on the encryption server may encrypt the data with the dynamic key to create an encrypted output. The encrypted output may include the encrypted data, a key identifier, and the random initialization vector, among other data.

The dynamic key encryption program on the encryption server may transmit the encrypted output to the user interface.

In an embodiment, the key identifier may include a dynamic key flag.

In an embodiment, the key identifier may include a standard encryption key flag.

In an embodiment, the network may be an internal intranet. An internal intranet may be more secure than the Internet or other network that may be accessible by a malicious actor. The encrypted data may, after encryption, be transmitted over a different network, such as the Internet, to a recipient.

In an embodiment, the key identifier and the random initialization vector may be in a header of the encrypted output. In an embodiment, the header may also include metadata.

In an embodiment, the key identifier and the random initialization vector may be in metadata of the encrypted output. In an embodiment, metadata may include a header.

In an embodiment, the header may be encrypted with a different encryption key. This may increase the security of the encryption by adding a second layer of encryption, specifically to the random initialization vector. In other embodiments, the random initialization vector may be in clear text with no encryption.

In an embodiment, the header may be encrypted with a different dynamic key than the encrypted data. This may increase the security of the encrypted output by adding an additional layer of encryption to the encrypted output.

A method for dynamic key encryption is provided. The method may include the step of creating an application-specific static symmetric key at a hardware security module proximate to an encryption server. In an embodiment, the hardware security module may be a component of the encryption server.

The method may include the step of transmitting the application-specific static symmetric key to the encryption server, when the hardware security module is separate from the encryption server. When the hardware security module is a component of the encryption server, the step of transmitting the application-specific static symmetric key may be omitted.

The method may include the step of receiving, at a dynamic key encryption program located on the encryption server, the application-specific static symmetric key from the hardware security module, when the hardware security module is separate from the encryption server. When the hardware security module is a component of the encryption server, the step of receiving the application-specific static symmetric key may be omitted.

The method may include the step of receiving, at the dynamic key encryption program and over a network, from a user interacting with a user interface on a user device: a request to encrypt data with a dynamic key, and the data.

The method may include the step of generating, at the dynamic key encryption program, a random initialization vector.

The method may include the step of generating, at the dynamic key encryption program, a hash of the random initialization vector with a hashing algorithm. Any suitable hashing algorithm may be used. The more complex the hashing algorithm, the more secure the hash may be.

The method may include the step of generating, at the dynamic key encryption program, an HMAC hash output of the hash with the application-specific symmetric key to create a dynamic key.

The method may include the step of encrypting, at the dynamic key encryption program, the data with the dynamic key to create an encrypted output. The encrypted output may include the encrypted data, a key identifier, and the random initialization vector.

The method may include the step of transmitting the encrypted output to the user interface.

In an embodiment, the encryption server may be centralized. In an embodiment, the encryption server may be decentralized.

In an embodiment the network may be the Internet, or an internal intranet.

In an embodiment, to decrypt the encrypted data, the method may further include the steps of: receiving the encrypted output from a user, determining that the encrypted output was generated with a dynamic key, parsing the random initialization vector from the encrypted output, generating a second hash of the random initialization vector with the hashing algorithm, generating a second HMAC hash output of the hash with the application symmetric key to re-create the dynamic key, and decrypting the encrypted data with the dynamic key.

In an embodiment, the determination that the encrypted output was generated with a dynamic key may be performed by an artificial intelligence/machine learning algorithm.

The dynamic key encryption program may utilize one or more artificial intelligence/machine learning (“AI/ML”) algorithms to perform one or more of its functions. Any suitable AI/ML algorithm may be used.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

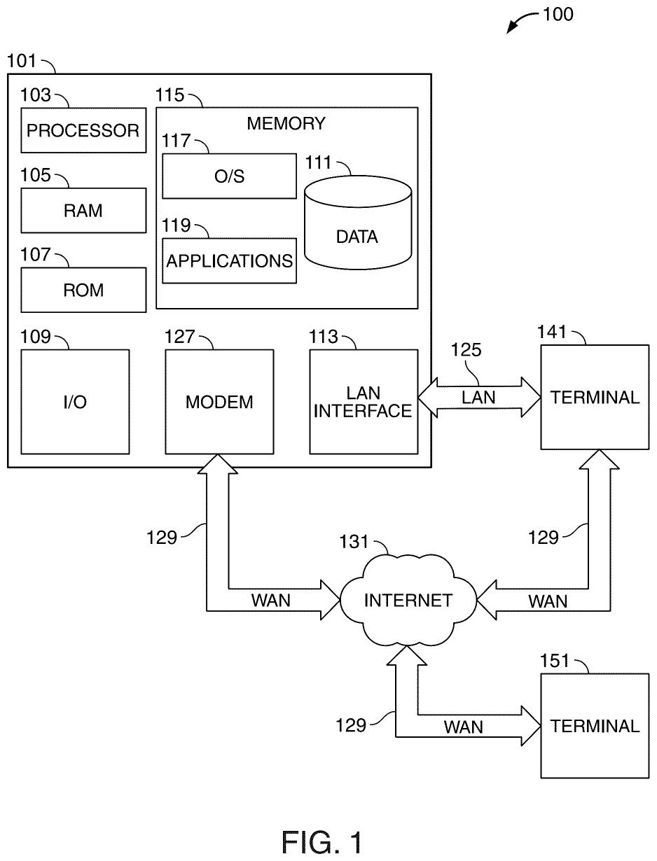

In accordance with principles of the disclosure, FIG. 1 shows an illustrative block diagram of apparatus 100 that includes a computer or computer system 101. Computer 101 may alternatively be referred to herein as a “computing device” or “computing system”. Computer 101 may be any suitable computing device or part of a computing device. Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more standard microprocessors 103 for controlling the operation of the device and its associated components, and may include RAM 105, ROM 107, input/output module 109, and a memory 115. The processors 103 may also execute all software running on the computer 101—e.g., the operating system 117 and applications 119 such as a dynamic key encryption program and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as the dynamic key encryption program and other applications) along with any other data 111 (e.g., static keys and authentication information for users and entities) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

In an embodiment of the server 101, the processor 103 may execute the instructions in all or some of the operating system 117, any applications 119 in the memory 115, any other code necessary to perform the functions in this disclosure, and any other code embodied in hardware or firmware (not shown).

An input/output (“I/O”) module 109 may include connectivity to a keyboard, monitor, microphone, or network interface through which higher hierarchal server or a user of server 101 may provide input. The input may include input relating to cursor movement. The input/output module 109 may also include one or more speakers for providing audio output and a video display device, such as an LED screen and/or touchscreen, for providing textual, audio, audiovisual, and/or graphical output (not shown).

In an embodiment, apparatus 100 may consist of multiple servers 101, along with other devices.

Apparatus 100 may be connected to other systems, computers, servers, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, or servers that include many or all of the elements described above relative to apparatus 100. The network connections depicted in FIG. 1 include a local area network (LAN) 125 and a wide area network (WAN) 129 but may also include other networks. Server 101 may include a network interface controller (not shown), which may include a modem 127 and LAN interface or adapter 113, as well as other components and adapters (not shown).

When used in a LAN networking environment, server 101 is connected to LAN 125 through a LAN interface or adapter 113. When used in a WAN networking environment, server 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The server may transmit data to any other suitable computer system. The server may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for invoking user functionality related to performing various tasks. In an embodiment, application program(s) 119 may be cloud-based applications. In an embodiment, application program(s) 119 may be programs such as a dynamic key encryption program and/or security protocols. In an embodiment, the dynamic key encryption program may use one or more AI/ML algorithm(s). The various tasks may be related generating dynamic encryption keys, encrypting data, and decrypting data.

Server 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, smart mobile device, or any other suitable device for receiving, storing, transmitting and/or displaying relevant information. Terminal 151 and/or terminal 141 may be other devices such as remote servers. The terminals 151 and/or 141 may be computers where the user is interacting with the application that is being monitored by apparatus 100.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, server computers, hand-held or laptop devices, tablets, mobile phones, smart phones, smart mobile devices, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

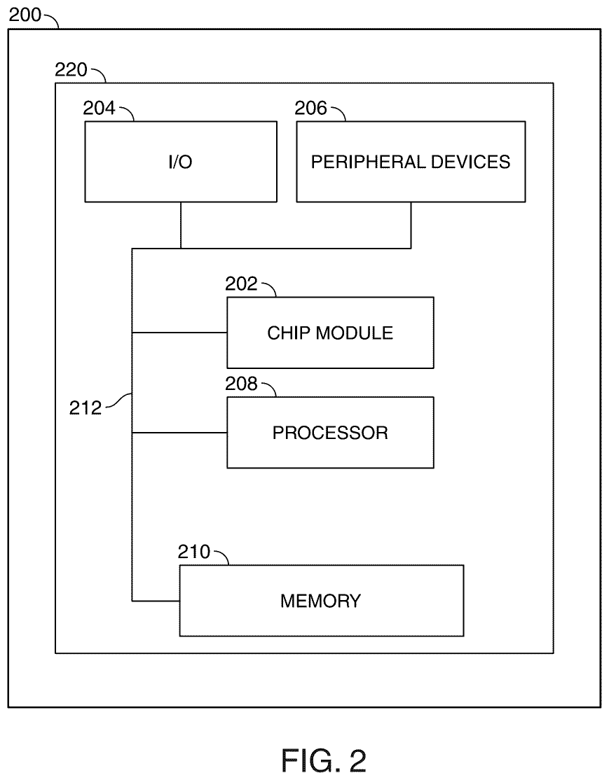

FIG. 2 shows illustrative apparatus 200 that may be configured in accordance with the principles of the disclosure. Apparatus 200 may be a server, user device, or other computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

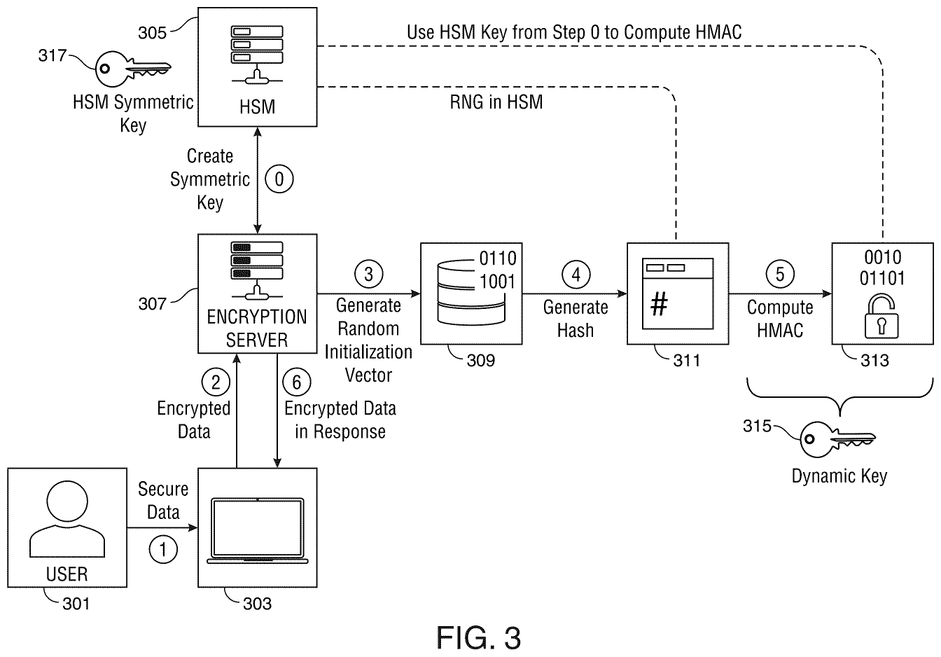

FIG. 3 shows an illustrative schematic to encrypt data with a dynamic key in accordance with principles of the disclosure. Apparatus may include the components numbered 301 through 317. Methods may include some or all of the method steps numbered 0 through 6. Methods may include the steps illustrated in FIG. 3 in an order different from the illustrated order. The illustrative method shown in FIG. 3 may include one or more steps performed in other figures or described herein. Steps 0 through 6 may be performed on the apparatus shown in FIGS. 1-4, and 6, or other apparatus.

A hardware security module (“HSM”) 305 may create an application symmetric key 317 at step 0. The application symmetric key may be shared with an encryption server 307. In an embodiment, the hardware security module 305 may be a part of encryption server 307.

A user 301 may input secure data, i.e., data to be encrypted, at a user device 303 at step 1.

The user device 303 may transmit a request to encrypt the data to the encryption server 307 at step 2.

At step 3, the encryption server may generate a random initialization vector (“IV”) 309 using a random number generator (“RNG”) from the HSM 305 or from an algorithm.

At step 4, the encryption server 307 may generate a hash 311 of the IV 309. The hash may be generated through a specific algorithm such as SHAKE256, or through a different algorithm.

At step 5, the encryption server 307 may use the symmetric key 317 and the hash 311 to compute a hash-based message authentication code (“HMAC”) 313. The HMAC 313 may then be used to create a dynamic key 315 by combining the HMAC with the symmetric key or through a different algorithm.

At step 6, the encryption server 307 may encrypt the data using the dynamic key 315 and transmit the encrypted data back to the user device 303.

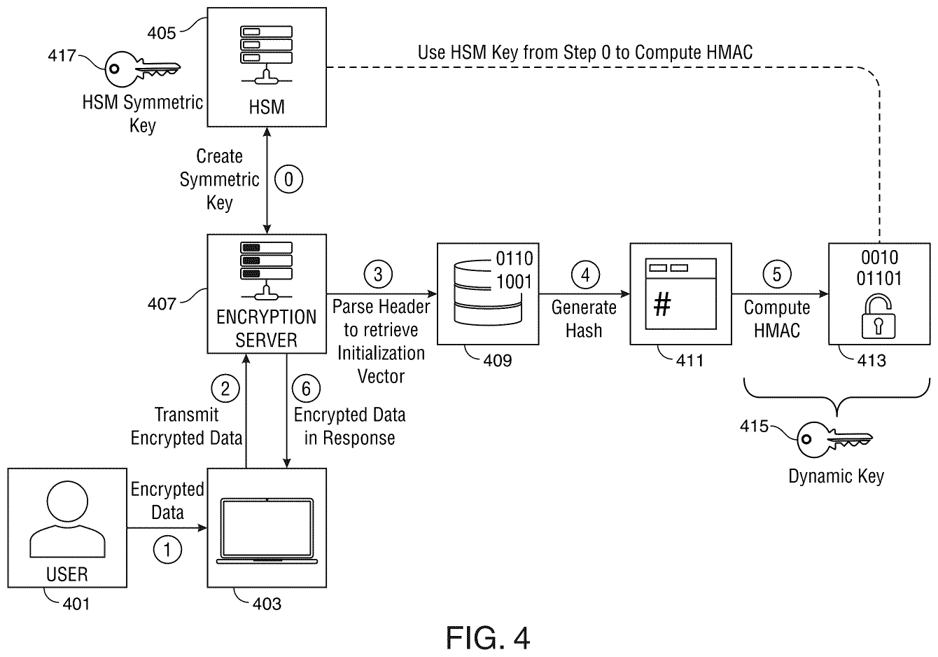

FIG. 4 shows an illustrative schematic to decrypt data encrypted with a dynamic key in accordance with principles of the disclosure. Apparatus may include the components numbered 401 through 417. Methods may include some or all of the method steps numbered 0 through 6. Methods may include the steps illustrated in FIG. 4 in an order different from the illustrated order. The illustrative method shown in FIG. 4 may include one or more steps performed in other figures or described herein. Steps 0 through 6 may be performed on the apparatus shown in FIGS. 1-4, and 6, or other apparatus.

A hardware security module (“HSM”) 405 may create an application symmetric key 417 at step 0. The application symmetric key may be shared with an encryption server 407. In an embodiment, the hardware security module 405 may be a part of encryption server 407.

A user 401 may input secure data, i.e., data encrypted with a dynamic key, at a user device 403 at step 1.

The user device 403 may transmit a request to decrypt the encrypted data to the encryption server 407 at step 2. The encryption server 407 should be the same encryption server used to encrypt the data.

At step 3, the encryption server may parse the header or other data of the encrypted data) to retrieve the random initialization vector (“IV”) 409 that was used to encrypt the data.

At step 4, the encryption server 407 may generate a hash 411 of the IV 409. The hash may be generated through a specific algorithm such as SHAKE256, or through a different algorithm. The hash should be generated with the same algorithm used when encrypting the data. The identity of the hashing algorithm may be included in the header or other data.

At step 5, the encryption server 407 may use the symmetric key 417 and the hash 411 to compute a hash-based message authentication code (“HMAC”) 413. The HMAC 413 may then be used to re-create a dynamic key 415. The dynamic key 415 computed at step 5 should be identical to the dynamic key used to encrypt the data.

At step 6, the encryption server 407 may decrypt the data using the dynamic key 415 and transmit the decrypted data back to the user device 403.

The decrypted data may be displayed on a user interface of the user device 403.

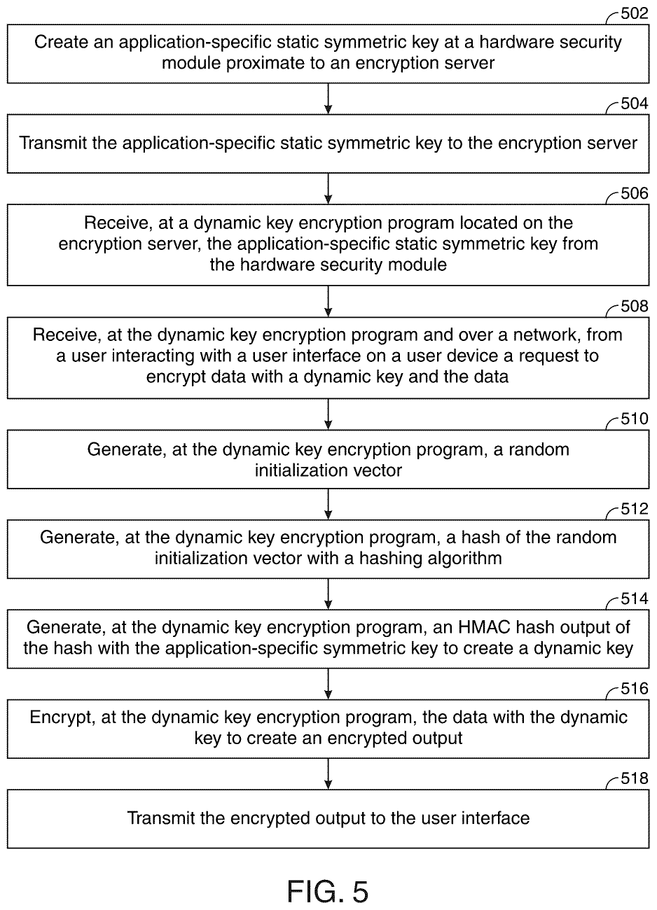

FIG. 5 shows an illustrative flowchart in accordance with principles of the disclosure. Methods may include some or all of the method steps numbered 502 through 518. Methods may include the steps illustrated in FIG. 5 in an order different from the illustrated order. The illustrative method shown in FIG. 5 may include one or more steps performed in other figures or described herein. Steps 502 through 518 may be performed on the apparatus shown in FIGS. 1-4, and 6, or other apparatus.

At step 502, an application specific static symmetric key may be created at a hardware security module. The hardware security module may be proximate to an encryption server. The hardware security module may be connected to an encryption server. The hardware security module may be connected over a network to an encryption server. In an embodiment, the hardware security module may be part of the encryption server.

At step 504, the hardware security module may transmit the application-specific symmetric key to the encryption server.

At step 506, a dynamic key encryption program located on the encryption server may receive the application-specific symmetric key from the hardware security module.

At step 508, the dynamic key encryption program may receive over a network and from a user interface on a user device, a request to encrypt data with a dynamic key, along with the unencrypted data.

At step 510, the dynamic key encryption program may generate a random initialization vector. In an embodiment, the random initialization vector may be generated by the hardware security module and transmitted to the dynamic key encryption program.

At step 512, the dynamic key encryption program may generate a hash of the random initialization vector with a hashing algorithm. Any appropriate hashing algorithm may be used.

At step 514, the dynamic key encryption program may generate an HMAC hash output of the hash of the random initialization vector and the static symmetric key to create a dynamic key.

At step 516, the dynamic key encryption program may encrypt the data with the dynamic key. This may create an encrypted output. The encrypted output may include the encrypted data, a key identifier, and the random initialization vector. The key identifier may identify the key used as a dynamic key or a different key for a different encryption protocol.

At step 518, the dynamic key encryption program may transmit the encrypted output to the user interface.

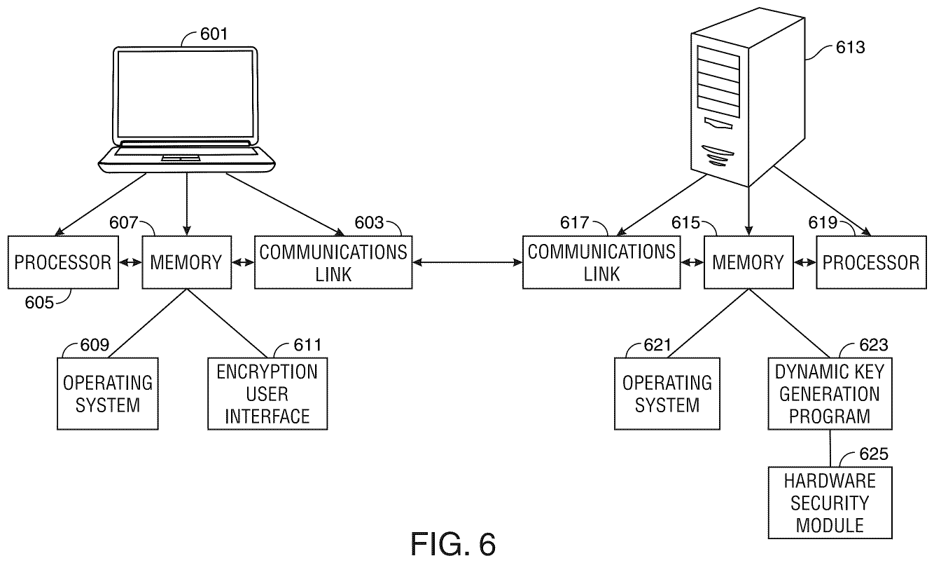

FIG. 6 shows an illustrative apparatus in accordance with principles of the disclosure. The apparatus may include a user device 601 and a computer system 613. Computer system 613 may be a centralized or decentralized encryption server.

User device 601 may include a device communications link 603, a standard processor/processors 605, a device non-transitory memory 607, as well as other components, such as a graphical user interface.

Computer system 613 may include a server communications link 617, a standard processor/processors 619, a server non-transitory memory 615, and a hardware security module 625, as well as other components, such as a graphical user interface. In an embodiment, hardware security module 625 may be separate from encryption server 613.

The device non-transitory memory 607, may include a device operating system 609, as well as a user interface program 611, as well as other data and programs.

The communications link 603 may communicate with other computer systems, such as computer system 613 and databases over a network.

The server non-transitory memory 615, may include a server operating system 621, as well as a dynamic key encryption program 623, as well as other data and programs.

Thus, apparatus and methods for dynamic key encryption using hardware security modules are provided. Persons skilled in the art will appreciate that the present invention can be practiced by other than the described embodiments, which are presented for purposes of illustration rather than of limitation.

What is claimed is:

1. An apparatus for dynamic key encryption, the apparatus comprising:
a central encryption server, the central server comprising:
a server communication link;
a server processor;
a hardware security module; and
a server non-transitory memory configured to store at least:
a server operating system; and
a dynamic key encryption program executed on the server processor; and
a user device, the user device comprising:
a device communication link;
a device processor; and
a device non-transitory memory configured to store at least:
a device operating system; and
a user interface program executed on the device processor and adapted to interact with the dynamic key encryption program;
wherein the dynamic key encryption program:
creates an application symmetric key with the hardware security module;
receives, over a network, a request for a dynamic key from a user interacting with the user interface;
generates a random initialization vector with the hardware security module;
generates a hash of the random initialization vector with a hashing algorithm;
generates an HMAC hash output of the hash with the application symmetric key to create a dynamic key; and
transmits the dynamic key to the user interface program; wherein the user interface program encrypts data with the dynamic key to create an encrypted output; and
wherein the encrypted output includes:
encrypted data;
a key identifier; and
the random initialization vector.

2. The apparatus of claim 1 wherein the network is the Internet.

3. The apparatus of claim 1 wherein the network is an internal intranet.

4. The apparatus of claim 1 wherein the application symmetric key is 256-bit.

5. The apparatus of claim 1 wherein the application symmetric key is longer than 256-bit.

6. The apparatus of claim 1 wherein the hashing algorithm comprises a SHAKE256 encryption algorithm.

7. The apparatus of claim 1 wherein to decrypt the encrypted data, the dynamic key encryption program:
receives the encrypted output;
determines that the encrypted output was generated with a dynamic key;
parses the random initialization vector from the encrypted output;
generates a second hash of the random initialization vector with the hashing algorithm;
generates a second HMAC hash output of the hash with the application symmetric key to re-create the dynamic key; and
decrypts the encrypted data with the dynamic key.

8. An apparatus for dynamic key encryption, the apparatus comprising:
a central encryption server, the central server comprising:
a server communication link;
a server processor; and
a server non-transitory memory configured to store at least:
a server operating system; and
a dynamic key encryption program executed on the server processor;
a hardware security module comprising a static symmetric key generator; and
a user device, the user device comprising:
a device communication link;
a device processor; and
a device non-transitory memory configured to store at least:
a device operating system; and
a user interface program executed on the device processor and adapted to interact with the dynamic key encryption program;
wherein the hardware security module:
creates an application-specific static symmetric key; and
transmits the application-specific static symmetric key to the central encryption server;
wherein the dynamic key encryption program:
receives the application-specific static symmetric key from the hardware security module;
receives, over a network, from a user interacting with the user interface:
a request to encrypt data with a dynamic key; and
the data;
generates a random initialization vector;
generates a hash of the random initialization vector with a hashing algorithm;
generates an HMAC hash output of the hash with the application-specific symmetric key to create a dynamic key;
encrypts the data with the dynamic key to create an encrypted output; and
transmits the encrypted output to the user interface; and
wherein the encrypted output includes:
the encrypted data;
a key identifier; and
the random initialization vector.

9. The apparatus of claim 8 wherein the key identifier includes a dynamic key flag.

10. The apparatus of claim 8 wherein the key identifier includes a standard key flag.

11. The apparatus of claim 10 wherein the network is an internal intranet.

12. The apparatus of claim 8 wherein the key identifier and the random initialization vector are in a header of the encrypted output.

13. The apparatus of claim 12 wherein the header is encrypted with a different encryption key.

14. The apparatus of claim 13 wherein the different encryption key is also a dynamic key.

15. The apparatus of claim 12 wherein the header comprises metadata.

16. A method for dynamic key encryption, the method comprising:
creating an application-specific static symmetric key at a hardware security module proximate to an encryption server;
transmitting the application-specific static symmetric key to the encryption server;
receiving, at a dynamic key encryption program located on the encryption server, the application-specific static symmetric key from the hardware security module;
receiving, at the dynamic key encryption program and over a network, from a user interacting with a user interface on a user device:
a request to encrypt data with a dynamic key; and
the data;
generating, at the dynamic key encryption program, a random initialization vector;
generating, at the dynamic key encryption program, a hash of the random initialization vector with a hashing algorithm;
generating, at the dynamic key encryption program, an HMAC hash output of the hash with the application-specific symmetric key to create a dynamic key;
encrypting, at the dynamic key encryption program, the data with the dynamic key to create an encrypted output; and
transmitting the encrypted output to the user interface;
wherein the encrypted output includes:
the encrypted data;
a key identifier; and
the random initialization vector.

17. The method of claim 16 wherein the encryption server is centralized.

18. The method of claim 16 wherein the network is the Internet.

19. The method of claim 16 wherein to decrypt the encrypted data, the method further comprises the steps of:
receiving the encrypted output from a user;
determining that the encrypted output was generated with a dynamic key;
parsing the random initialization vector from the encrypted output;
generating a second hash of the random initialization vector with the hashing algorithm;
generating a second HMAC hash output of the hash with the application symmetric key to re-create the dynamic key; and
decrypting the encrypted data with the dynamic key.

20. The method of claim 19 wherein the determination that the encrypted output was generated with a dynamic key is performed by an artificial intelligence/machine learning algorithm.
